(19) United States
(12) Patent Application Publication
(10) Pub. No.: US 2008/0185554 A1
(43) Pub. Date: Aug. 7, 2008

(54) TREATED MAGNETIZABLE PARTICLES AND METHODS OF MAKING AND USING THE SAME

(75) Inventors: John C. Ulicny, Oxford, MI (US); Tao Xie, Troy, MI (US); Mark A. Golden, Washington, MI (US); Andrew M. Mance, Royal Oak, MI (US); Keith S. Snavely, Sterling Heights, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 11/971,298

(22) Filed: Jan. 9, 2008

Related U.S. Application Data
(60) Provisional application No. 60/884,049, filed on Jan. 9, 2007.

(51) Int. Cl. H01F 1/00

(52) U.S. Cl. 252/62.55; 252/62.51 R

(57) ABSTRACT

Magnetizable particles treated with a silane precursor comprising a hydrophobic group.

This application claims the benefit of U.S. Provisional Application No. 60/884,049 filed Jan. 9, 2007.

### TECHNICAL FIELD

The field to which the disclosure generally relates includes treated magnetizable particles and methods of making and using the same.

### BACKGROUND

Magnetorheological (MR) fluids may generally include a suspension of micron-sized magnetizable particles, pure iron for example, in a carrier fluid, hydrocarbon oil, for example. When placed in a magnetic field, the apparent viscosity of MR fluids can increase by several orders of magnitude which makes this material useful in torque transfer devices and dampers, for example.

### SUMMARY OF EXAMPLARY EMBODIMENTS OF THE INVENTION

One embodiment of the invention includes a method comprising: treating magnetizable particles with a silane precursor comprising a hydrophobic group.

Another embodiment of the invention includes a method comprising: applying a magnetic field to magnetorheological fluid comprising magnetizable particles and a silicate coating thereon comprising a hydrophobic group to cause the viscosity of the fluid to increase.

Another embodiment of the invention includes a method comprising: hydrolyzing a silane; mixing magnetizable particles, the hydrolyzed silane and a vehicle together for a sufficient time to produce coated particles comprising the magnetizable particles coated with a hydrophobic protective coating; condensing any hydroxyl groups on the coating; and separating the coated particles from the vehicle.

Another embodiment of the invention includes a product comprising: a magnetorheological fluid comprising magnetizable particles and a silicate coating thereon comprising a hydrophobic group to cause the viscosity and off-state yield stress of the fluid to decrease.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a graph comparing the oxidation of various treated and untreated iron powders as a function of temperature including a treated iron powder according to one embodiment of the invention.

FIG. 2 is a graph of the magnetic yield stress of various MR fluids including a MR fluid according to one embodiment of the invention.

FIG. 3 illustrates a sol-gel process for the treatment of iron particles according to one embodiment of the invention.

### DETAILED DESCRIPTION OF EXEMPLARY EMBODIMENTS

The following description of the embodiment(s) is merely exemplary in nature and is in no way intended to limit the invention, its application, or uses.

One embodiment of the invention may include the use of a new coating material, octyltriethoxysilane (OTES), for the magnetizable particles used to prepare magnetorheological (MR) fluids. The use of this coating in various embodiments of the invention may provide the following advantages: oxidation protection for the iron particles; a hydrophobic character to the particle surface which may allow the particle to be used to make MR fluids in water or other chemically polar liquids including high boiling alcohols and glycols; lower off-state viscosity and yield stress as compared to MR fluids prepared with uncoated iron particles; minimal reduction in magnetic properties and on-state yield stress as compared to other coatings; and a simple, room temperature coating procedure.

Comparative testing has shown that the coating according to one embodiment inhibits oxidation of the iron particles in air at elevated temperature and makes the particle surface hydrophobic. Further, the on-state yield stress of a MR fluid made with coated particles is only slightly reduced and the off-state viscosity and yield stress are greatly reduced as compared to a similar fluid made with uncoated particles.

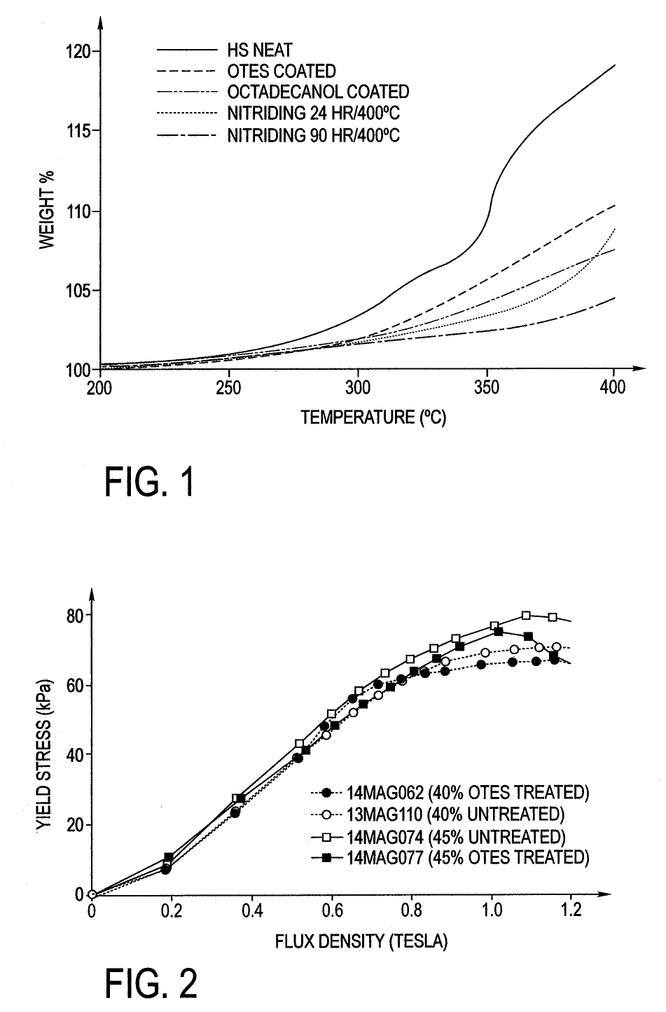

Comparative oxidation performance is shown in FIG. 1 as compared to the neat material (ie., uncoated material), octadecanol-treated powder and nitriding under various conditions. Examples of octadecanol-treated powder are disclosed in U.S. patent application Ser. No. 2005/139550 and examples of nitriding are disclosed in U.S. Pat. No. 6,929,757. The OTES coating provides better oxidation protection than the octadecanol and approaches the effectiveness of the nitriding

The hydrophobic character of the particles after treatment according to one embodiment of the invention was demonstrated by placing a small quantity of the powder on a pool of water. The particles floated on the surface and did not readily sink to the bottom of the pool as untreated material will do.

The on-state properties of an MR fluid prepared with treated particles are shown in FIG. 2 in comparison with a similar MR fluid prepared with untreated particles. This FIG. 2 shows that the treatment has only a small effect on the yield stress.

Finally, the OTES-coating provides an unexpected benefit in the form of greatly reduced off-state viscosity and yield stress. As shown in Table 1, the viscosity of 40 and 45 volume percent iron MR fluids is reduced by about a factor of four and the yield stress is reduced by more than a factor of 8-10 as compared to similar MR fluids prepared with untreated particles. This reduction in apparent viscosity will translate into reduced off-state drag when the MR fluid is used in a damper or torque transfer device.

TABLE 1
Off-state viscosity and yield stress for 40 and
45% MR fluids prepared with OTES-treated iron.

| Sample | Iron Volume | | Viscosity | Yield Stress |
|---|---|---|---|---|
| Code | Fraction | Treatment | 40° C. [cp] | 40° C. [Pa] |
| 13MAG110 | 40% | untreated | 543 | 415 |
| 14MAG062 | 40% | treated | 128 | 37 |
| 14MAG074 | 45% | untreated | 514 | indistinct |
| 14MAG077 | 45% | treated | 136 | 57 |

In one embodiment of the invention the treatment of magnetizable particles, for example iron powder, for an MR fluid application, may include a sol-gel method. In this particular example, a silicate coating on the surface of iron powder was found to enhance the oxidative stability by thermogravimetric analysis (TGA; e.g., FIG. 1), but with noticeable drop in MR performance. The particular silicate coating based on tetraethoxysilane (TEOS) is hydrophilic in nature, and does not offer any surface hydrophobicity that is expected to serve as a water barrier to further retard the oxidation of iron powder (H. Pu, F. Jiang, and Z. Yang, Materials Letters, 60 (2006) 94-97.).

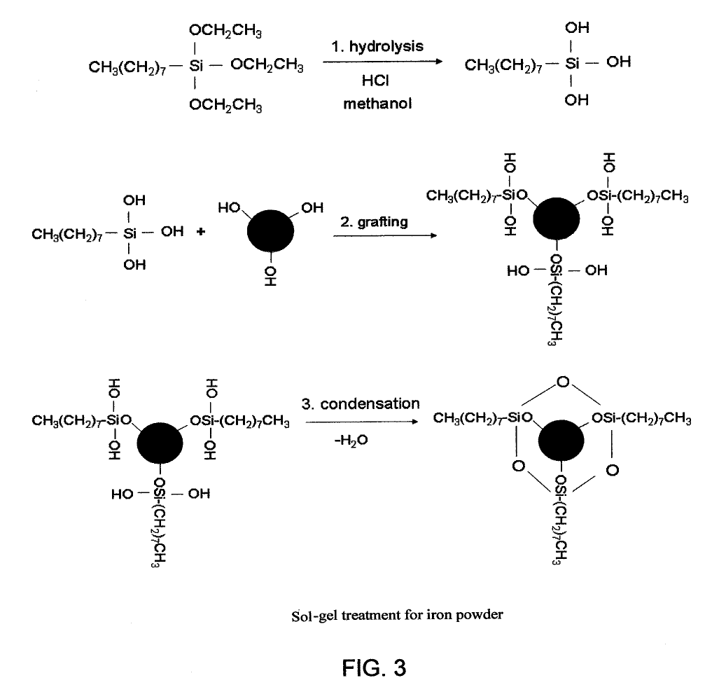

One facile method to introduce hydrophobicity onto metal surfaces uses sol-gel chemistry based on a silane precursor that contains a hydrophobic group, for instance, a fluoroalkyl group. In one embodiment of the invention, OTES, a silane that containing a long octyl group, may be selected as a sol-gel precursor to produce a hydrophobic protective coating onto iron powder. The reactions for the sol-gel treatment of iron powder are shown in FIG. 3. The first reaction was the hydrolysis of the silane to produce the corresponding silanol, which was then grafted onto iron particles through the reaction between the hydroxyl groups on the silanol and those on iron particles. The remaining unreacted hydroxyl groups on the silanol underwent condensation reaction to form O—Si—O bonds. Upon the completion of all the reaction, iron particles surrounded by the hydrophobic octyl groups were produced.

It is notable that the reactions may be carried out at ambient conditions requiring only a few simple reaction steps in contrast to the high temperatures, anaerobic atmosphere and relatively difficult extraction steps required for the octadecanol reactions.

### EXAMPLE 1

Experimental procedure: 500 g of iron powder was weighed into a plastic container, followed by the addition of 600 ml of methanol, 33 ml of octyltriethoxysilane (OTES), and 5.4 g of water. 1 ml of concentrated HCl was then added dropwise. After the addition of all the above ingredients, the plastic container was sealed with a cap and kept shaken for 5 hours at room temperature using a paint shaker . Upon the completion of the reaction, iron powder was separated with a magnet and washed three times with 600 ml of methanol. In the final step, the iron powder was dried at 90 C. in an oven for 16 hours

One embodiment of the invention includes a MR fluid including magnetizable particles with a protective hydrophobic coating thereon, and a carrier fluid. The particles with the coating there on may be present in about 50 to about 95 weight percent and the carrier fluid may be present in about 50 to about 5 weight percent of the total fluid. The hydrophobic groups generally may be nonpolar, additional examples of which include linear aliphatic, branched aliphatic and linear or branched aromatic chains. For example, the protective coating may include hydrophobic groups including, but not limited to methyl, ethyl, pentyl, hexyl, heptyl and/or octyl or longer hydrocarbon chains. In one embodiment of the invention the coating on the particle may be present in about 0.01 to about 0.1 weight percent of the particle with the coating thereon. In various embodiments the carrier may include at least one of water, an alcohol, a glycol or polyol, silicone oil or hydrocarbon oil. Examples of suitable alcohols include, but are not limited to, heptanol, benzyl alcohol, ethylene glycol and/or polypropylene glycol. Examples of suitable hydrocarbon oils include, but are not limited to, poly-alpha-olefins (PAO, mineral oils and/or polydimethylsiloxanes. Other suitable materials for the carrier are described hereafter. Suitable magnetizable particles are available from BASF Company under the trade name CM and HS, for example. MR fluid (MRF) according to embodiment of the invention may be used in a variety of applications including in, but not limited to, shock absorbers, clutches, motor mounts, valves, haptic or other fluid control devices. A magnetic flux density ranging from about 0.01 Tesla to about 2 Tesla, for example, may be applied to the MRFs to increase the viscosity thereof when used in such devices.

The MRF described here is designed to work in the following environment: temperature range=−40° C. to +300° C. (internal device temperature); magnetic flux density=0 to 1.6 Tesla; gravitation field=1 to 1300 g. Preferred example: A typical working environment (e.g., an automotive fan drive) consists of an ambient temperature of 65° C. (150° F.), magnetic flux density of 0.6 Tesla and gravitational field of 500 g. The MRF must withstand not only the ambient temperature but also the transient temperatures generated during the operation of a clutch which, internally, can reach the range indicated. The MRF may have a low viscosity at the low end of the indicated temperature range so that a device such as a fan drive will operate at minimal speed when engine cooling is not required. The fluid must provide a suitable range of yield stress for the device so as to provide sufficient torque to drive a cooling fan, for example. The gravitational field exerted on the fluid is a consequence of the rotary motion of the device, and it tends to separate the iron particles from the suspension. The suspension must be robust enough to withstand these artificial gravitation forces without separation.

Solids suitable for use in the fluids include magnetizable, low coercivity (i.e., little or no residual magnetism when the magnetic field is removed), finely divided particles of iron, nickel, cobalt, iron-nickel alloys, iron-cobalt alloys, iron-silicon alloys and the like which may be spherical or nearly spherical in shape and may have a diameter in the range of about 0.1 to 100 microns. Since the particles may be employed in noncolloidal suspensions, it is preferred that the particles be at the small end of the suitable range, preferably in the range of 1 to 10 microns in nominal diameter or particle size. The particles used in MRFs are larger and compositionally different than the particles that are used in “ferrofluids” which are colloidal suspensions of, for example, very fine particles of iron oxide having diameters in the 10 to 100 nanometers range. Ferrofluids operate by a different mechanism from MRFs. MRFs are suspensions of solid particles which tend to be aligned or clustered in a magnetic field and drastically increase the effective viscosity or flowability of the fluid.

A suitable magnetizable solid phase may include CM carbonyl iron powder and HS carbonyl iron powder, both manufactured by BASF Corporation. The carbonyl iron powders are gray, finely divided powders made from pure metallic iron. The carbonyl iron powders are produced by thermal decomposition of iron pentacarbonyl, a liquid which has been highly purified by distillation. The spherical particles include carbon, nitrogen and oxygen. These elements give the particles a core/shell structure with high mechanical hardness. CM carbonyl iron powder includes more than 99.5 wt % iron, less than 0.05 wt % carbon, about 0.2 wt % oxygen, and less than 0.01 wt % nitrogen, which a particle size distribution of less than 10% at 4.0 μm, less than 50% at 9.0 μm, and less than 90% at 22.0 μm, with true density >7.8 g/cm³. The HS carbonyl iron powder includes minimum 97.3 wt % iron, maximum 1.0 wt % carbon, maximum 0.5 wt % oxygen, maximum 1.0 wt % nitrogen, with a particle size distribution of less than 10% at 1.5 μm, less than 50% at 2.5 μm, and less than 90% at 3.5 μm. As indicated, the weight ratio of CM to HS carbonyl powder may range from 3:1 to 1:1 but preferably is about 1:1. In one embodiment of the invention the total solid phase (carbonyl iron) may be present in 86 to 90 wt % of the MRF.

Examples of other iron alloys which may be used as magnetorheological particles include iron-cobalt and iron-nickel alloys. Iron-cobalt alloys may have an iron-cobalt ratio ranging from about 30:70 to about 95:5 and preferably from about 50:50 to about 85:15, while the iron-nickel alloys have an iron-nickel ratio ranging from about 90:10 to about 99:1 and preferably from about 94:6 to 97:3. The iron alloys may contain a small amount of other elements such as vanadium, chromium, etc., in order to improve ductility and mechanical properties of the alloys. These other elements are typically present in amounts less than about 3.0 percent total by weight.

The magnetorheological particles may be in the form of metal powders. The particle size of magnetorheological particles treated by the method and materials as disclosed herein may be selected to exhibit bimodal characteristics when subjected to a magnetic field. Average particle diameter distribution size of the magnetorheological particles is generally between about 1 and about 100 microns, with ranges between about 1 and about 50 microns being preferred.

The magnetorheological particles may be present in bimodal distributions of large particles and small particles with large particles having an average particle size distribution between about 5 and about 30 microns. Small particles may have an average particle size distribution between about 1 and about 10 microns. In the bimodal distributions as disclosed herein, it is contemplated that the average particle size distribution for the large particles will typically exceed the average particle size distribution for the small particles in a given bimodal distribution. Thus, in situations where the average particle distribution size for large particles is 5 microns, for example, the average particle size distribution for small particles will be below that value. Examples of suitable magnetorheological fluids having bimodal particle distributions include those disclosed in U.S. Pat. No. 5,667,715 to Foister.

The particles may be spherical in shape. However, it is also contemplated that magnetorheological particles may have irregular or nonspherical shapes as desired or required. Additionally, a particle distribution of nonspherical particles as disclosed herein may have some nearly spherical particles within its distribution. Where carbonyl iron powder is employed, it is contemplated that a significant portion of the particles will have a spherical or near spherical shape.

The magnetorheological particles can be integrated into a suitable carrier fluid. Suitable carrier fluids can suspend the MR particles but are essentially nonreactive. Such fluids include, but are not limited to, water, organic fluids or oil-based fluids. Examples of suitable organic and/or oil based carrier fluids include, but are not limited to, cyclo-paraffin oils, paraffin oils, natural fatty oils, mineral oils, polyphenol ethers, dibasic acid esters, neopentylpolyol esters, phosphate esters, polyesters, synthetic cyclo-paraffin oils and synthetic paraffin oils, unsaturated hydrocarbon oils, monobasic acid esters, glycol esters and ethers, silicate esters, silicone oils, silicone copolymers, synthetic hydrocarbon oils, perfluorinated polyethers and esters, halogenated hydrocarbons, and mixtures or blends thereof. Hydrocarbon oils, such as mineral oils, paraffin oils, cyclo-paraffin oils (also as napthenic oils), and synthetic hydrocarbon oils may be employed as carrier fluids. Synthetic hydrocarbon oils include those oils derived from the oligomerization of olefins such as polybutenes and oils derived from higher alpha olefins of from 8 to 20 carbon atoms by acid catalyzed dimerization, and by oligomerization using tri-aluminum alkyls as catalysts. Such poly-alpha olefin oils can be employed as preferred carrier fluids. It is also contemplated that the oil may be a suitable material such as oils derived from vegetable materials. The oil of choice may be one amenable to recycle and reprocessing as desired or required.

The carrier fluid of choice may have a viscosity between about 2 and about 1,000 centipoises at 25° C. with a viscosity between about 3 and about 200 centipoises being preferred and a viscosity between about 5 and about 100 centipoises being particularly preferred. It is contemplated that the carrier fluid portion and magnetorheological particles can be admixed to provide a composition having magnetorheological particles in an amount between about 5 and about 50 percent by volume, with amounts between 10 and 45 percent by volume being preferred, and amounts between about 20 and 45 percent by volume being particularly preferred. This corresponds to about 30 to about 90 percent by weight, with amounts between 45 and 90 percent by weight being preferred, and amounts between 65 and 90 percent by weight being particularly preferred based on the carrier fluid and particle component of the magnetorheological material having specific gravities in the range of 0.8-0.9 and 7.5-8.0, respectively.

A suitable vehicle (liquid phase) or carrier of the MRF is a hydrogenated polyalphaolefin (PAO) base fluid, designated SHF21, manufactured by Mobil Chemical Company. The material is a homopolymer of 1-decene which is hydrogenated. It is a paraffin-type hydrocarbon and has a specific gravity of 0.82 at 15.6° C. It is a colorless, odorless liquid with a boiling point ranging from 375° C. to 505° C., and a pour point of −57° C. In one embodiment of the invention, the liquid phase may be present in 10 to 14 wt % of the MRF.

Another embodiment of the invention includes a magnetorheological fluid (MFR) including 10 to 14 wt % of a polyalphaolefin liquid, 86 to 90 wt % of treated magnetizable particles, optionally up to 0.5 wt % fumed silica, and optionally up to 5 wt % (of the liquid mass) of a liquid phase additives. The magnetizable particles include at least one of iron, nickel and cobalt-based materials.

In the preferred embodiment of this invention, fumed silica is added in about 0.05 to 0.5, preferably 0.5 to 0.1, and most preferably 0.05 to 0.06 weight percent of the MRF. The fumed silica is a high purity silica made from high temperature hydrolysis having a surface area in the range of 100 to 300 square meters per gram.

The above description of embodiments of the invention is merely exemplary in nature and, thus, variations thereof are not to be regarded as a departure from the spirit and scope of the invention.

1. A method comprising:
treating magnetizable particles with a silane precursor comprising a hydrophobic group.

2. A method as set forth in claim 1 wherein the silane precursor comprises octyltriethoxysilane.

3. A method as set forth in claim 1 wherein the hydrophobic group is —CH₃(CH₂)₇.

4. A method as set forth in claim 1 wherein the particles each comprise iron.

5. A method comprising:
applying a magnetic field to magnetorheological fluid comprising magnetizable particles and a silicate coating thereon comprising hydrophobic group to cause the viscosity of the fluid to increase.

6. A method as set forth in claim 5 wherein the fluid further comprises a carrier present in about 5 to about 50 weight percent of the fluid.

7. A method as set forth in claim 6 wherein the carrier comprises water.

8. A method as set forth in claim 6 wherein the carrier comprises an alcohol.

9. A method as set forth in claim 6 wherein the carrier comprises hydrocarbon oil.

10. A method as set forth in claim 6 wherein the particles are present in about 50 to about 95 weight percent of the fluid.

11. A method as set forth in claim 5 wherein the silicate coating comprises SiOCH₃(CH₂)₇ groups.

12. A method as set forth in claim 11 wherein the magnetizable particles comprise iron powder.

13. A method comprising:
hydrolyzing a silane;
mixing magnetizable particles, the hydrolyzed silane and a solvent together for a sufficient time to produce coated particles comprising the magnetizable particles coated with a hydrophobic protective coating;
condensing any hydroxyl groups on the coating;
separating the coated particles from the solvent.

14. A method as set forth in claim 13 wherein the silane comprises an octyl group.

15. A method as set forth in claim 13 wherein the silane comprises octyltriethoxysilane.

16. A method as set forth in claim 13 further comprising adding the coated particles to a carrier vehicle to form a magnetoreological fluid and applying a magnetic field to the magnetoreological fluid.

17. A product comprising:
a magnetorheological fluid comprising magnetizable particles and a silicate coating thereon comprising hydrophobic group.

18. A product as set forth in claim 17 wherein the fluid further comprises a carrier present in about 5 to about 50 weight percent of the fluid.

19. A product as set forth in claim 17 wherein the coating is present in about 0.01 to about 0.1 weight percent of the particle with the coating thereon.

20. A product as set forth in claim 17 wherein the silicate coating comprises SiOCH₃(CH₂)₇ groups.
